(19) United States
(12) Patent Application Publication
(10) Pub. No.: US 2016/0057562 A1
(43) Pub. Date: Feb. 25, 2016

(54) System frame number information transmission method, base station, terminal and system

(71) Applicant: ZTE CORPORATION, Shenzhen, Guangdong (CN)

(72) Inventors: Huiying Fang, Shenzhen (CN); Bo Dai, Shenzhen (CN); Jing Shi, Shenzhen (CN); Shuqiang Xia, Shenzhen (CN); Xincai Li, Shenzhen (CN); Shupeng Li, Shenzhen (CN)

(21) Appl. No.: 14/780,376

(22) PCT Filed: Oct. 25, 2013
(86) PCT No.: PCT/CN2013/086010

§ 371 Date: Sep. 25, 2015

(30) Foreign Application Priority Data
Mar. 29, 2013 (CN) 201310110191.2

(51) Int. Cl. H04W 4/00; H04W 72/04

(52) U.S. Cl. CPC H04W 4/005; H04W 72/044

(57) ABSTRACT

A method and a system for transmitting System Frame Number (SFN) information. The method includes that a base station sets X resource locations for carrying SFN indication information in one SFN information cycle period; and the base station transmits the SFN indication information at at least one resource location in each SFN information cycle period. Moreover, a base station and a terminal are provided in order to improve the coverage performance of a smart metering Machine Type Communication (MTC) terminal device deployed in a low-coverage environment and ensure the normal communication requirement of the MTC terminal device without additional deployment of a site and a relay station.

### TECHNICAL FIELD

The disclosure relates to the field of wireless communications, and more particularly to a method, a base station, a terminal and a system for transmitting System Frame Number (SFN) information.

### BACKGROUND

The Machine Type Communication (MTC) User Equipment (UE), which is also called a Machine to Machine (M2M) user communication device, is a main application form of the existing Internet of things. Low power consumption and cost are the important safeguard of the large-scale application of the MTC device. Smart metering is one of the most typical applications of the MTC device, and most of the smart metering MTC devices are fixedly installed in an environment of low coverage performance, such as a basement. To ensure the normal communication between the MTC device and a base station system, the additional deployment of a site, a relay and other devices is usually needed, which may greatly increase the deployment cost of an operator absolutely. Therefore, the Vodafone and other companies require improvement of the coverage of the smart metering MTC device without additional deployment in the technical solution RP-121282 OF THE 3GPP RAN.

A smart metering MTC device, which mainly transmits small-packet data, has a low requirement on the data rate and can tolerate a relatively large data transmission delay. Because the smart metering MTC device has a very low requirement on the data rate, for a data channel, the correct transmission of the small-packet data can be ensured by a lower modulation encoding rate, multiple repeated transmissions in a time domain and other ways. However, for the SFN information needing to be transmitted to a terminal, the frame number information in the existing LTE system is contained in a Master Information Block (MIB) to be transmitted, and the scheduling period of transmitting the MIB is 40 ms, as shown in FIG. 1, the MIB is transmitted repeatedly for four times on a broadcast channel of sub-frame 0 of each radio frame. The MIB remains unchanged within every 40 ms, while the SFN of the next MIB may change, thus, the data of the broadcast channel cannot improve the coverage performance by a long-time time domain repetition. The smart metering MTC device deployed in a low-coverage environment can tolerate a large time delay, and transmission performance can be ensured for control signaling, such as resource configuration, and data transmission by multiple repeated transmission in a time domain, but the MTC device cannot communicate with a base station system normally due to the low transmission performance of the MIB. To reduce the cost of the smart metering MTC terminal device which is fixedly installed, the MTC terminal device only supports system bandwidth of 1.4 MHz.

In addition, in terms of some traditional UEs in a low-coverage environment, the improved rate of correct reception of SFN information by a terminal device is the premise of ensuring the normal communication between the terminal device and a base station system.

In order to ensure the normal communication between the terminal device and the base station system by ensuring that the terminal device can receive SFN information correctly on the premise of improving the coverage performance of the terminal device which is fixedly installed in a low-coverage environment without deployment of additional relay device, it is necessary to design a new way for transmitting SFN information for a terminal device in a low-coverage environment.

### SUMMARY

In view of this, the main objective of the disclosure is to provide a method a base station, a terminal and a system for transmitting SFN information, in order to improve the coverage performance of a smart metering MTC terminal device deployed in a low-coverage environment and ensure the normal communication requirement of the MTC terminal device without additional deployment of a site and a relay station.

To this end, the technical solutions of the embodiments of the disclosure are implemented as follows.

An embodiment of the disclosure provides a method for transmitting SFN information, including:

a base station sets X resource locations for carrying SFN indication information in one SFN information cycle period; and

the base station transmits the SFN indication information at at least one resource location in each SFN information cycle period.

In the solution, each resource location may consist of a single radio frame or consecutive M radio frames.

In the solution, X=2^{Y}, Y>=0 and Y<=10; and

the M may be 2, 4, 8, 16, 32 or 64.

In the solution, the method may further include: when X=1, in one SFN cycle period, the base station sets one resource location for carrying the SFN indication information, and in two adjacent SFN cycle periods, an interval between resource locations for transmitting the SFN indication information is set to be equal to the SFN cycle period, which has a length of 1024 radio frames.

In the solution, the method may further include: when X=1024 and the cycle period is 1024, in the SFN cycle period, the resource location for carrying the SFN indication information is set to be all the radio frames in the SFN cycle period, and each resource location is set to correspond to one radio frame.

In the solution, when 0<Y<10, the initial radio frame numbers of the X resource locations are allocated at an equal interval in the SFN cycle period.

In the solution, the method may further include: when 0<Y<10 and each resource location consists of a single radio frame, the base station repeatedly transmits the SFN indication information over single radio frames at an interval of P=2^{10-Y} radio frames.

In the solution, the method may further include: the SFN indication information is encoded and the encoded SFN indication information is transmitted at the resource location; or, the SFN indication information is mapped into a predefined sequence, and the predefined sequence corresponding to the SFN indication information is transmitted at the resource location.

In the solution, the SFN indication information is an MIB of a Long Term Evolution (LTE) system, or other indication information containing an SFN.

In the solution, the other indication information containing an SFN may include: indication information only including an SFN, or indication information including an SFN and repetition times of a system message, or indication information including an SFN and repetition times of a control channel, or indication information including an SFN, repetition times of a system message and repetition times of a control channel.

In the solution, the method may further include: the SFN indication information is transmitted over K sub-frames of each of the consecutive M radio frames, where K is 1, 2, 4, 5 or 10.

In the solution, the method may further include: an enhanced broadcast channel bearing the SFN indication information is transmitted within the K sub-frames, wherein two or four Orthogonal Frequency Division Multiplexing (OFDM) symbols in one sub-frame, or all the available OFDM symbols in one time slot, or all the available symbols except the first three symbols in one sub-frame, or all the available OFDM symbols in one sub-frame are used for transmitting the enhanced broadcast channel.

In the solution, the method may further include: the consecutive M radio frames are divided into H radio frame groups, wherein different radio frame groups correspond to different scrambling codes, and H is an integer more than or equal to 1 and less than or equal to M; and each radio frame group includes L radio frames, the SFN indication information is encoded and then divided into L parts, and each part is repeatedly transmitted within one radio frame.

In the solution, the method may further include:

the base station divides the SFN indication information into two parts, and the two parts of information are transmitted over different channels respectively.

An embodiment of the disclosure provides a method for transmitting SFN information, including:

a terminal detects SFN indication information which is transmitted at each resource location in an SFN information cycle period to obtain an SFN of a current frame, wherein

X resource locations for carrying the SFN indication information are set in one SFN information cycle period.

In the solution, the method may further include that, when X=1, the terminal acquires the SFN indication information at an interval of 1024 radio frames by blind detection in each SFN cycle period.

In the solution, the method may further include: when X=1024 and the cycle period is 1024, the terminal detects the SFN indication information transmitted over each radio frame to acquire the SFN indication information.

In the solution, the method may further include: when the SFN indication information is encoded and then transmitted at the resource location, the terminal carries out decoding according to a corresponding encoding method, or, when the SFN indication information is mapped into a predefined sequence and the sequence corresponding to the SFN indication information is transmitted at the resource location, the terminal carries out detection according to the corresponding sequence.

In the solution, the method may further include: when each resource location consists of consecutive M radio frames, the terminal carries out detection with the consecutive M radio frames as a unit.

In the solution, the method may further include: when the consecutive M radio frames are divided into H radio frame groups, the terminal carries out decoding according to a scrambling code sequence corresponding to each radio frame group.

In the solution, the method may further include: when the SFN indication information is encoded and then divided into L parts, the terminal carries out decoding according to a dividing way of the SFN indication information.

In the solution, the method may further include: when the SFN indication information is divided into two parts, the terminal carries out decoding according to a channel corresponding to each part to acquire the SFN indication information.

An embodiment of the disclosure provides a base station, including a setting module and a transmitting module, wherein

the setting module is configured to set X resource locations for carrying SFN indication information in an SFN information cycle period; and

the transmitting module is configured to transmit the SFN indication information at at least one resource location in each SFN information cycle period.

In the solution, each resource location may consist of a single radio frame and consecutive M radio frames.

In the solution, X=2^{Y}, Y>=0 and Y<=10;

the M is 2, 4, 8, 16, 32 or 64.

In the solution, the setting module may be configured to: when X=1, in one SFN cycle period, set one resource location for carrying the SFN indication information, and in two adjacent SFN cycle periods, set an interval between resource locations for transmitting the SFN indication information to be equal to the SFN cycle period, which has a length of 1024 radio frames.

In the solution, the setting module may be configured to: when X=1024 and the cycle period is 1024, set the resource location for carrying the SFN indication information to be all the radio frames in the SFN cycle period and set each resource location to correspond to one radio frame in the SFN cycle period.

In the solution, when 0<Y<10, the initial radio frame numbers of the X resource locations may be allocated at an equal interval in the SFN cycle period.

In the solution, the transmitting module may be configured to: when 0<Y<10 and each resource location consists of a single radio frame, repeatedly transmit the SFN indication information over single radio frames at an interval of P=2^{10-Y} radio frames.

In the solution, the transmitting module may be configured to encode the SFN indication information and transmit the encoded SFN indication information at the resource location; or, map the SFN indication information into a predefined sequence, and transmit the sequence corresponding to the SFN indication information at the resource location.

In the solution, the SFN indication information may be an MIB of an LTE system, or other indication information containing an SFN.

In the solution, the other indication information containing an SFN may include: indication information only including an SFN, or indication information including an SFN and repetition times of a system message, or indication information including an SFN and repetition times of a control channel, or indication information including an SFN, repetition times of a system message and repetition times of a control channel.

In the solution, the transmitting module may be configured to transmit the SFN indication information over K sub-frames of each of the consecutive M radio frames, where K is 1, 2, 4, 5 or 10.

In the solution, the transmitting module may be further configured to transmit an enhanced broadcast channel bearing the SFN indication information in the K sub-frames, wherein two or four OFDM symbols in one sub-frame, or all the available OFDM symbols in one time slot, or all the available symbols except the first three symbols in one sub-frame, or all the available OFDM symbols in one sub-frame are used for transmitting the enhanced broadcast channel.

In the solution, the transmitting module may be further configured to: divide the consecutive M radio frames into H radio frame groups, wherein different radio frame groups correspond to different scrambling codes, and H is an integer more than or equal to 1 and less than or equal to M; and each radio frame group includes L radio frames, the SFN indication information is encoded and then divided into L parts, and each part is repeatedly transmitted within one radio frame.

In the solution, the transmitting module may be further configured to divide the SFN indication information into two parts, and transmit the two parts of information over different channels respectively.

One embodiment of the disclosure provides a terminal, including:

a detecting module, which is configured to detect SFN indication information which is transmitted at each resource location in an SFN cycle period to obtain an SFN of a current frame, wherein

X resource locations for carrying the SFN indication information are set in one SFN information cycle period.

In the solution, the terminal may further include a computing module, which is configured to compute an SFN of a subsequent radio frame.

In the solution, the detecting module may be configured to, when X=1, acquire the SFN indication information at an interval of 1024 radio frames by blind detection in each SFN cycle period.

In the solution, the detecting module may be configured to: when X=1024 and the cycle period is 1024, detect the SFN indication information transmitted over each radio frame to acquire the SFN indication information.

In the solution, the detecting module may be configured to: when the SFN indication information is encoded and then transmitted at the resource location, carry out decoding according to a corresponding encoding method, or, when the SFN indication information is mapped into a predefined sequence and the sequence corresponding to the SFN indication information is transmitted at the resource location, carry out detection according to a corresponding sequence.

In the solution, the detecting module may be configured to: when each resource location consists of consecutive M radio frames, carry out detection with the consecutive M radio frames as a unit.

In the solution, the detecting module may be further configured to: when the consecutive M radio frames are divided into H radio frame groups, carry out decoding according to a scrambling code sequence corresponding to each radio frame group.

In the solution, the detecting module may be further configured to: when the SFN indication information is encoded and then divided into L parts, carry out decoding according to a dividing way of the SFN indication information.

In the solution, the detecting module may be further configured to: when the SFN indication information is divided into two parts, carry out decoding according to a channel corresponding to each part to acquire the SFN indication information.

An embodiment of the disclosure further provides a system for transmitting SFN information, including the base station and the terminal mentioned above.

According to the method, the base station, the terminal and the system for transmitting SFN information, provided by the embodiments of the disclosure, the base station sets X resource locations for carrying SFN indication information in one SFN information cycle period; the base station transmits the SFN indication information at at least one resource location in each SFN information cycle period; and the terminal detects the SFN indication information which is transmitted at each resource location in the SFN information cycle period to obtain an SFN of a current frame and computes an SFN of a subsequent radio frame; thus, the coverage performance of a smart metering MTC terminal device deployed in a low-coverage environment can be improved, and the normal communication requirement of the MTC terminal device can be ensured without additional deployment of a site and a relay station.

### BRIEF DESCRIPTION OF THE DRAWINGS

FIG. 1 is a diagram showing the transmission of an MIB in the conventional art;

FIG. 2 is a diagram showing the flow of a first method for transmitting SFN information in an embodiment of the disclosure;

FIG. 3 is a diagram showing the flow of a second method for transmitting SFN information in an embodiment of the disclosure;

FIG. 4 is a diagram showing a structure of a system for transmitting SFN information in an embodiment of the disclosure;

FIG. 5 is a diagram showing the repeated transmission of SFN indication information over radio frames at an interval of an SFN cycle period in a Frequency Division Duplexing (FDD) system in an embodiment of the disclosure;

FIG. 6 is a diagram showing the repeated transmission of SFN indication information over radio frames at an interval of an SFN cycle period in a Time Division Duplexing (TDD) system in an embodiment of the disclosure;

FIG. 7 is a diagram showing the repeated transmission of SFN indication information over each radio frame in an SFN cycle period in an embodiment of the disclosure;

FIG. 8 is a diagram showing the repeated transmission of SFN indication information over single radio frames at an interval of 2^{10-Y} (0<Y<10) in an FDD system in an embodiment of the disclosure;

FIG. 9 is a diagram showing the repeated transmission of SFN indication information over single radio frames at an interval of 2^{10-Y} (0<Y<10) in a TDD system in an embodiment of the disclosure;

FIG. 10 is a diagram showing resource locations for repeatedly transmitting SFN indication information on consecutive 2, 4, or 8 radio frames at an interval of 2^{10-Y} (0<Y<10) in an embodiment of the disclosure;

FIG. 11 is a diagram showing the symbol level of resources transmitted by a base station for repeatedly transmitting SFN indication information over consecutive multiple radio frames in an FDD system in an embodiment of the disclosure; and

FIG. 12 is a diagram showing the symbol level of resources transmitted by a base station for repeatedly transmitting SFN indication information over consecutive multiple radio frames in a TDD system in an embodiment of the disclosure.

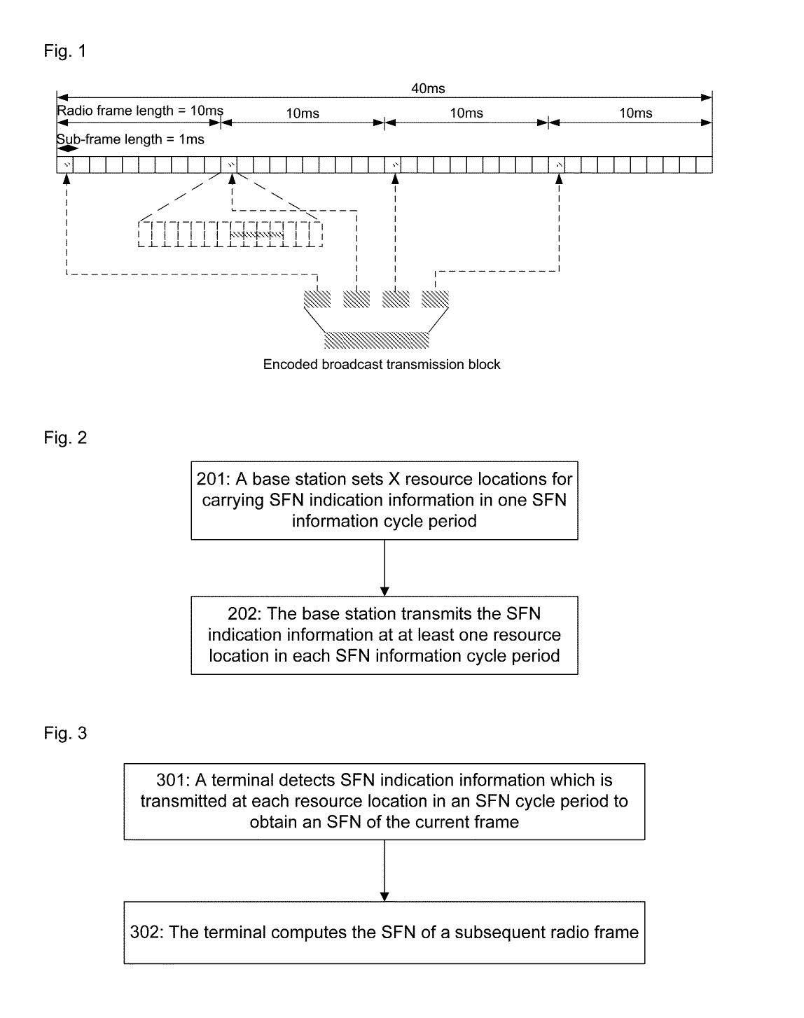

### DETAILED DESCRIPTION

In the embodiments, a base station sets X resource locations for carrying SFN indication information in one SFN information cycle period; the base station transmits the SFN indication information at at least one resource location in each SFN information cycle period; and a terminal detects the SFN indication information which is transmitted at each resource location in an SFN cycle period to obtain an SFN of a current frame and computes an SFN of a subsequent radio frame.

The disclosure is preferably described below through the drawings and embodiments in detail.

An embodiment of the disclosure implements a method for transmitting SFN information, as shown in FIG. 2, the method includes the following steps:

Step 201: A base station sets X resource locations for carrying SFN indication information in an SFN information cycle period.

Here, each resource location consists of a single radio frame or consecutive M radio frames; the M is 2, 4, 8, 16, 32 or 64; and X=2^{Y}, Y>=0 and Y<=10.

The step may further include: when X=1, in one SFN information cycle period, the base station sets one resource location for carrying SFN indication information, and in two adjacent SFN cycle periods, the interval between resource locations for transmitting SFN indication information is set to be equal to the SFN cycle period, which has a length of 1024 radio frames; and

when X=1024 and the cycle period is 1024, in one SFN cycle period, the resource location for carrying the SFN indication information is set to be all the radio frames in the SFN cycle period, and each resource location is set to correspond to one radio frame.

Preferably, when 0<Y<10, the initial radio frame numbers of X resource locations are allocated at an equal interval in the SFN cycle period; and the interval between resource locations is: a fixed radio frame interval P=2^{10-Y}, where Y is generally less than or equal to 5.

Step 202: The base station transmits the SFN indication information at at least one resource location in each SFN information cycle period.

Here, the SFN indication information is the MIB of an LTE system or other indication information containing an SFN; and the other indication information containing an SFN includes: indication information only including an SFN, or indication information including an SFN and repetition times of a system message, or indication information including an SFN and repetition times of a control channel, or indication information including an SFN, repetition times of a system message and repetition times of a control channel.

The step may further include: the SFN indication information is encoded and then transmitted at the resource location; or, the SFN indication information is mapped into a predefined sequence, and the sequence corresponding to the SFN indication information is transmitted at the resource location.

Preferably, when 0<Y<10 and each resource location consists of a single radio frame, the base station repeatedly transmits the SFN indication information over single radio frames at an interval of P=2^{10-Y} radio frames.

Generally, the base station transmits the indication information including an SFN over a radio frame with an SFN of 2^{10-Y}−1, 2^{11-Y}−1, . . . , 1023.

Preferably, the SFN indication information is transmitted over K sub-frames of each of the consecutive M radio frames, where K is 1, 2, 4, 5 or 10.

Preferably, an enhanced broadcast channel bearing the SFN indication information is transmitted within the K sub-frames, wherein two or four OFDM symbols in one sub-frame, or all the available OFDM symbols in one time slot, or all the available symbols except the first three symbols in one sub-frame, or all the available OFDM symbols in one sub-frame are used for transmitting the enhanced broadcast channel.

Preferably, the consecutive M radio frames are divided into H radio frame groups, and different radio frame groups correspond to different scrambling codes, where H is an integer more than or equal to 1 and less than or equal to M.

Each radio frame group includes L radio frames, the SFN indication information is encoded and then divided into L parts, and each part is repeatedly transmitted within one radio frame.

The step may further include: the base station divides the SFN indication information into two parts, and the two parts of information are transmitted on different channels respectively. For example, the higher n bits of the SFN indication information are taken as a first part, and the remaining bits are taken as a second part; or, the lower n bits of the SFN indication information are taken as a first part, and the remaining bits are taken as a second part; the first part is transmitted in a System Information Block (SIB) or in an enhanced Physical Downlink Control Channel (e-PDCCH), and the second part is transmitted on an enhanced Physical Broadcast Channel (ePBCH); or, the first part is transmitted on a primary ePBCH, and the second part is transmitted on a secondary ePBCH; or, the first part is transmitted on an ePBCH, and the second part is transmitted on a Physical Downlink Shared Channel (PDSCH).

Based on the method, an embodiment of the disclosure may further provide a method for transmitting SFN information, as shown in FIG. 3, the method includes Step 301.

Step 301: A terminal detects SFN indication information which is transmitted at each resource location in an SFN cycle period to obtain an SFN of the current frame, wherein

X resource locations for carrying SFN indication information are set in an SFN information cycle period.

Specifically, when X=1, the terminal acquires the SFN indication information which is repeatedly transmitted over single radio frames at an interval of 1024 radio frames by blind detection in each SFN cycle period; and

when X=1024 and the cycle period is 1024, the terminal detects the SFN indication information transmitted over each radio frame to acquire the SFN indication information.

When the SFN indication information is encoded and then transmitted at the resource location, the terminal carries out decoding according to a corresponding encoding method; or, when the SFN indication information is mapped into a predefined sequence and the sequence corresponding to the SFN indication information is transmitted at the resource location, the terminal carries out detection according to the corresponding sequence.

When each resource location consists of consecutive M radio frames, the terminal carries out detection by taking the consecutive M radio frames as a unit, specifically, when each resource location consists of consecutive M radio frames and is at an interval of P=2^{10-Y} radio frames, where 0<Y<10, the terminal detects the MIB of an LTE system repeatedly transmitted over consecutive M radio frames at an interval of 2^{10-Y} radio frames, and combines the MIB of the LTE system with the MIB received from a traditional broadcast message for decoding to obtain the SFN.

Preferably, when the consecutive M radio frames are divided into H radio frame groups, the terminal carries out decoding according to a scrambling code sequence corresponding to each radio frame group.

Preferably, when the SFN indication information is encoded and then divided into L parts, the terminal carries out decoding according to the dividing way of the SFN indication information.

When the SFN indication information is divided into two parts, the terminal carries out decoding according to a channel corresponding to each part to acquire the SFN indication information.

The method further includes Step 302: the terminal computes the SFN of a subsequent radio frame.

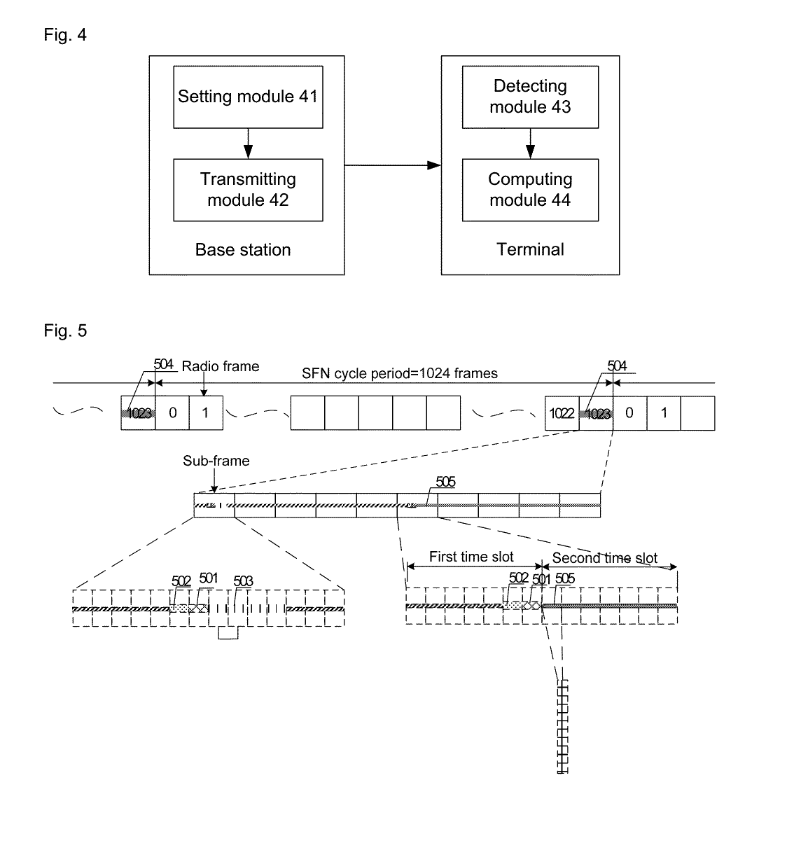

To implement the method, an embodiment of the disclosure provides a base station. As shown in FIG. 4, the base station includes a setting module 41 and a transmitting module 42, wherein

the setting module 41 is configured to set X resource locations for carrying SFN indication information in one SFN information cycle period;

the transmitting module 42 is configured to transmit SFN indication information at at least one resource location in each SFN information cycle period; and

the setting module 41 and the transmitting module 42 can be implemented by a Central Processing Unit (CPU), a Digital Signal Processor (DSP) or a Field Programmable Gate Array (FPGA) in the base station.

Here, each resource location consists of a single radio frame or consecutive M radio frames; the M is 2, 4, 8, 16, 32 or 64; and X=2^{Y}, Y>=0 and Y<=10.

The setting module 41 is specifically configured to: when X=1, in one SFN cycle period, set one resource location for carrying the SFN indication information, and in two adjacent SFN cycle periods, set the interval between resource locations for transmitting the SFN indication information to be equal to the SFN cycle period, which has a length of 1024 radio frames.

The SFN indication information includes an indicating sequence or encoding information.

The setting module 41 is specifically configured to: when X=1024 and the cycle period is 1024, in one SFN cycle period, set the resource location for carrying the SFN indication information to be all the radio frames in the SFN cycle period and set each resource location to correspond to one radio frame.

Preferably, when 0<Y<10, the initial radio frame numbers of the X resource locations are allocated at an equal interval in the SFN cycle period.

The transmitting module 42 is specifically configured to: when 0<Y<10 and each resource location consists of a single radio frame, repeatedly transmit the SFN indication information over single radio frames at an interval of P=2^{10-Y} radio frames.

The transmitting module 42 is specifically configured to encode the SFN indication information and transmit the encoded SFN indication information at the resource location; or, map the SFN indication information into a predefined sequence, and transmit the sequence corresponding to the SFN indication information at the resource location.

The SFN indication information is the MIB of an LTE system or other indication information containing an SFN; and the other indication information containing an SFN includes: indication information only including an SFN, or indication information including an SFN and repetition times of a system message, or indication information including an SFN and repetition times of a control channel, or indication information including an SFN, repetition times of a system message and repetition times of a control channel.

The transmitting module 42 is specifically configured to transmit the SFN indication information over K sub-frames of each of the consecutive M radio frames, where K is 1, 2, 4, 5 or 10.

The transmitting module 42 is further configured to transmit an enhanced broadcast channel bearing the SFN indication information in the K sub-frames, wherein two or four OFDM symbols in one sub-frame, or all the available OFDM symbols in one time slot, or all the available symbols except the first three symbols in one sub-frame, or all the available OFDM symbols in one sub-frame are used for transmitting the enhanced broadcast channel.

The transmitting module 42 is further configured to: divide the consecutive M radio frames into H radio frame groups, wherein different radio frame groups correspond to different scrambling codes, and H is an integer more than or equal to 1 and less than or equal to M.

Each radio frame group includes L radio frames, the SFN indication information is encoded and then divided into L parts, and each part is repeatedly transmitted in one radio frame.

The transmitting module 42 is further configured to divide the SFN indication information into two parts, and the two parts of information are transmitted on different channels respectively.

One embodiment of the disclosure further provides a terminal, as shown in FIG. 4, including:

a detecting module 43, which is configured to detect SFN indication information which is transmitted at each resource location in an SFN cycle period to obtain an SFN of the current frame, wherein

X resource locations for carrying SFN indication information are set in one SFN information cycle period.

The terminal may further include a computing module 44, which is configured to compute the SFN of a subsequent radio frame.

The detecting module 43 and the computing module 44 can be implemented by a CPU, a DSP or an FPGA.

The detecting module 43 is specifically configured to, when X=1, acquire the SFN indication information at an interval of 1024 radio frames by blind detection in each SFN cycle period.

The detecting module 43 is specifically configured to: when X=1024 and the cycle period is 1024, detect the SFN indication information transmitted over each radio frame to acquire the SFN indication information.

The detecting module 43 is specifically configured to: when the SFN indication information is encoded and then transmitted at the resource location, carry out decoding according to a corresponding encoding method, or, when the SFN indication information is mapped into a predefined sequence and the sequence corresponding to the SFN indication information is transmitted at the resource location, carry out detection according to the corresponding sequence.

The detecting module 43 is specifically configured to: when each resource location consists of consecutive M radio frames, carry out detection with the consecutive M radio frames as a unit.

The detecting module 43 is further configured to: when the consecutive M radio frames are divided into H radio frame groups, carry out decoding according to a scrambling code sequence corresponding to each radio frame group.

The detecting module 43 is further configured to: when the SFN indication information is encoded and then divided into L parts, carry out decoding according to the dividing way of the SFN indication information.

The detecting module is further configured to: when the SFN indication information is divided into two parts, carry out decoding according to the channel corresponding to each part to acquire the SFN indication information.

An embodiment of the disclosure further provides a system for transmitting SFN information, as shown in FIG. 4, including the base station and the terminal.

The process and principle of the implementation of the steps of this disclosure are specified with the following detailed embodiments.

### First Embodiment

In the embodiment, the scenario of repeatedly transmitting SFN indication information over a sub-frame of single radio frames at an interval of an SFN cycle period in an FDD or a TDD system is mainly described.

As shown in FIG. 2, the specific processing step on a base station side includes:

Step 201: A base station sets X resource locations for carrying SFN indication information in an SFN information cycle period;

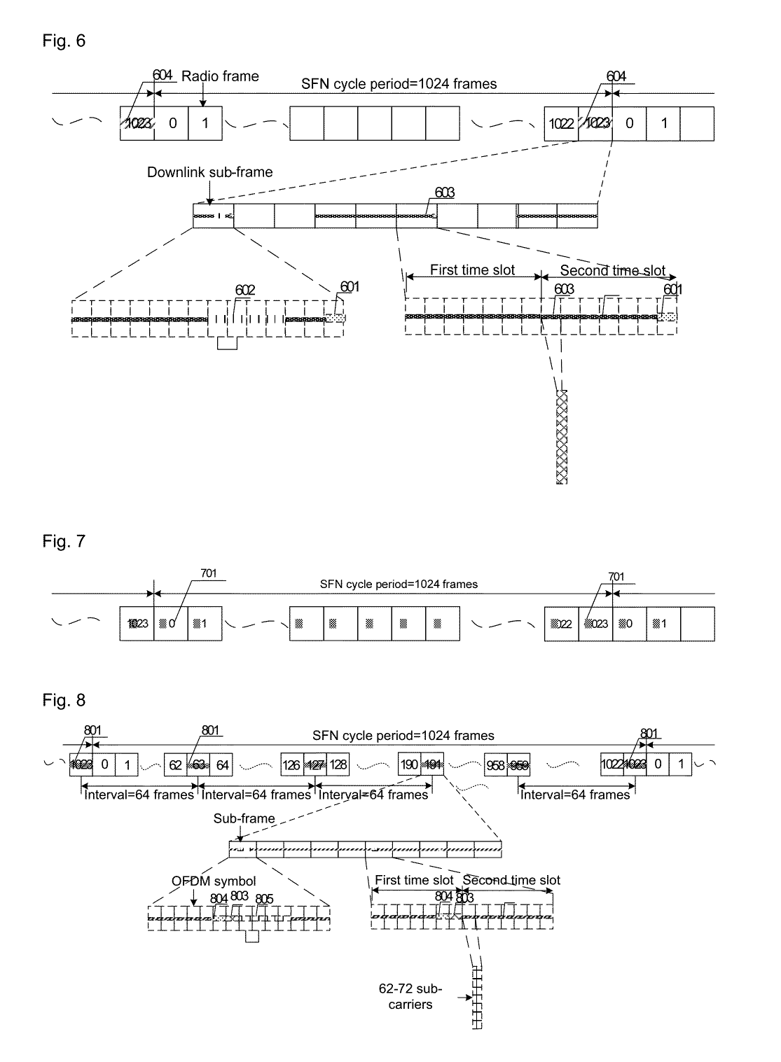

here, each resource location consists of a single radio frame; as shown in FIGS. 5 and 6, in one SFN cycle period, the base station sets one resource location for carrying SFN indication information, and in two adjacent SFN cycle periods, the base station sets the interval between resource locations for transmitting SFN indication information to be equal to the SFN cycle period, which has a length of 1024 radio frames; and

Step 202: The base station transmits the SFN indication information at at least one resource location in each SFN information cycle period, and the SFN indication information includes an SFN corresponding to the resource location.

The method for transmitting SFN indication information may include: the SFN indication information is encoded and then transmitted at the resource location; or, the SFN indication information is mapped into a pre-defined sequence, and the sequence corresponding to the SFN indication information is transmitted at the resource location.

As shown in FIGS. 4 and 5, the base station repeatedly transmits the SFN indication information over a radio frame 504 or 604 with an SFN of 1023, and the SFN indication information includes the SFN corresponding to the radio frame 504 or 604.

The SFN indication information is mapped into a predefined sequence or encoding information, the sequence may be an m sequence, a CAZAC sequence and the like, and the sequence occupies less than or equal to 72 subcarriers in a frequency domain.

In the embodiment shown in FIG. 5 or 6, the known indicating sequence 505 or 603 or the encoding information corresponds to the SFN 1023; as shown in FIG. 5, in an FDD system, the base station can repeatedly transmit the SFN indication information over all the symbols of a single radio frame except a primary synchronous symbol 501, a secondary synchronous symbol 502 and the symbol 503 where a broadcast channel is located; and as shown in FIG. 6, in a TDD system, the base station can repeatedly transmit the SFN indication information over all the symbols of all the downlink sub-frames of a single radio frame except a secondary synchronous symbol 601 and the symbol 602 where the broadcast channel is located.

As shown in FIG. 3, the processing step on a terminal side includes:

Step 301: A terminal detects SFN indication information which is transmitted at each resource location in an SFN cycle period to obtain an SFN of the current frame.

As shown in FIG. 5, the base station repeatedly transmits the indication information containing an SFN over a radio frame 504 or 604 with the SFN of 1023, and maps the repeatedly transmitted SFN indication information into a predefined sequence or encoding information; and the terminal detects the repeatedly transmitted sequence or the encoding information and determines that the current SFN is 1023.

Step 302: Before acquiring a next SFN, the terminal computes the SFN of a subsequent radio frame according to own timing.

In the embodiment, by transmitting the SFN indication information repeatedly and densely over the radio frame where the SFN is located before its cycle period jumps, the synchronization of SFN information between an MTC terminal device and a base station side in a low-coverage environment can be ensured on the premise of reducing the system overhead, and the normal communication requirement of the MTC terminal device can be ensured.

### Second Embodiment

In the embodiment, the scenario of repeatedly transmitting SFN indication information over each radio frame in an SFN cycle period in an FDD or a TDD system is described.

As shown in FIG. 2, the specific processing step on a base station side includes:

Step 201: A base station sets X resource locations for carrying the SFN indication information in an SFN information cycle period.

Here, each resource location consists of a single radio frame; as shown in FIG. 7, in one SFN information cycle period, the base station sets 1024 resource locations 701 for carrying SFN indication information, namely, the resource locations 701 are on respective radio frames in the SFN cycle period.

Step 202: The base station transmits the SFN indication information at at least one resource location in each SFN information cycle period, and the SFN indication information includes the SFN corresponding to each resource location.

As shown in FIG. 7, the base station repeatedly transmits the SFN indication information on each radio frame; the SFN indication information includes the SFN corresponding to each radio frame; the SFN indication information may be the MIB of a traditional LTE system, and other indication information containing an SFN; and the other indication information containing an SFN may be SFN information, or the combination information of an SFN and repetition times of a system message/a control message.

As shown in FIG. 3, the processing step on a terminal side includes:

Step 301: A terminal detects SFN indication information which is transmitted at each resource location in an SFN cycle period to obtain an SFN of the current frame.

Here, if the SFN indication information transmitted repeatedly is the MIB of a traditional LTE system, the terminal combines the detected SFN indication information with the MIB received from a traditional broadcast message for decoding to obtain the SFN.

Step 302: Before acquiring a next SFN, the terminal computes the SFN of a subsequent radio frame according to own timing.

In the embodiment, by additionally adding low-density repeatedly-transmitted SFN indication information to each radio frame in an SFN cycle period, the synchronization performance of SFN information between an MTC terminal device and a base station side in a low-coverage environment is improved without increasing the system overhead obviously.

### Third Embodiment

In the embodiment, the scenario of repeatedly transmitting SFN indication information over single radio frames at an interval of 2^{10-Y} (0<Y<10) radio frames is mainly described in an FDD system or a TDD system.

As shown in FIG. 2, the specific processing step of a base station side includes:

Step 201: A base station sets X resource locations for carrying SFN indication information in an SFN information cycle period.

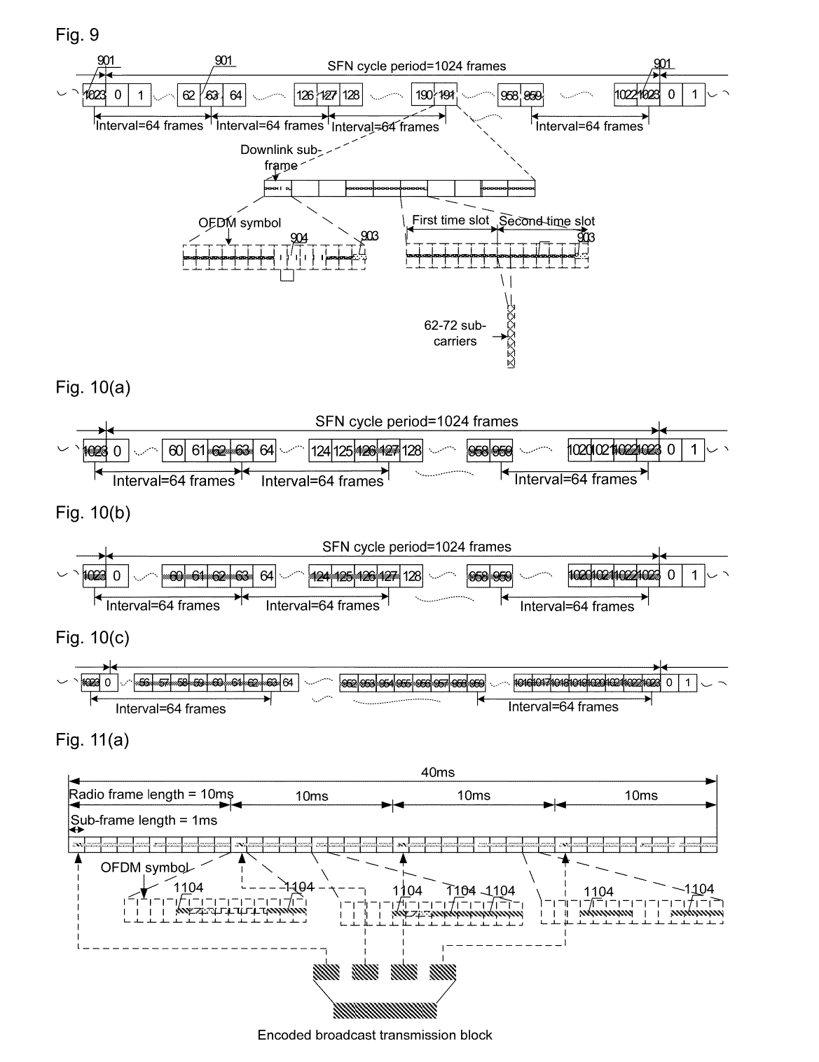

Here, each resource location consists of a single radio frame; as shown in FIGS. 8 and 9, X=2^{Y}=16, 16 resource locations for carrying SFN indication information are allocated at an equal interval in an SFN cycle period, and the interval between resource locations is a preset fixed radio frame internal, i.e., P=2^{10-Y}=64 radio frames.

Step 202: The base station transmits the SFN indication information at at least one resource location in each SFN information cycle period, and the SFN indication information includes an SFN corresponding to the resource location.

As shown in FIGS. 8 and 9, the base station repeatedly transmits the SFN indication information over radio frames with SFNs of 63, 127, 191, . . . , 895, 959 and 1023; as shown in FIG. 8, in an FDD system, the base station can repeatedly transmit the SFN indication information on all the symbols of a radio frame 801 except a primary synchronous symbol 803, a secondary synchronous symbol 804 and the symbol 805 where a broadcast channel is located; and as shown in FIG. 9, in a TDD system, the base station can repeatedly transmit the SFN indication information on all the symbols of all the downlink sub-frames (except special sub-frames) of the radio frame 901 except a secondary synchronous symbol 903 and the symbol 904 where the broadcast channel is located.

The method for transmitting SFN indication information may include: the SFN indication information is encoded and then transmitted at the resource location; or, the SFN indication information is mapped into a pre-defined sequence, and the sequence corresponding to the SFN indication information is transmitted at the resource location.

The mapping relationship between the SFN and the sequence/SFN indication information (information source corresponding to the encoding) is predefined, as shown in Table 1.

TABLE 1

| Number of resource | Sequence/SFN | Represented SFN |
|---|---|---|
| location | indication information | information |
| 0 | 1 | SFN = D/X − 1 |
| 1 | 2 | SFN = 2 * D/X − 1 |
| . . . | | |
| X | x + 1 | SFN = (x + 1) * D/X − 1 |
| . . . | | |
| X − 1 | X | SFN = D − 1 |

As shown in FIG. 3, the processing step on a terminal side includes:

Step 301: A terminal detects SFN indication information which is transmitted at each resource location in an SFN information cycle period to obtain an SFN of the current frame.

As shown in FIGS. 8 and 9, the interval between resource locations is a preset fixed radio frame interval, i.e., P=2^{10-Y}=64 radio frames; the terminal detects the SFN indication information which is repeatedly transmitted on radio frames with SFNs of 63, 127, 191, . . . , 895, 959 and 1023 to obtain the SFN of the current radio fame according to a predefined mapping relationship between the SFN and the sequence/SFN indication information in Table 1.

Step 302: Before acquiring a next SFN, the terminal computes the SFN of a subsequent radio frame according to own timing.

In the embodiment, by transmitting the SFN indication information repeatedly and densely over single radio frames at an interval of 2^{10-Y} (0<Y<10) radio frames, the synchronization of SFN information between an MTC terminal device and a base station side in a low-coverage environment can be ensured on the premise of reducing the system overhead without influencing the time delay of synchronizing the SFN of the terminal obviously, and the normal communication requirement of the MTC terminal device can be ensured.

### Fourth Embodiment

In the embodiment, the scenario of repeatedly transmitting SFN indication information over consecutive multiple radio frames at an interval of 2^{10-Y} (0<Y<10) radio frames is mainly described in an FDD or a TDD system.

As shown in FIG. 2, the specific processing step of a base station side includes:

Step 201: A base station sets X resource locations for carrying SFN indication information in an SFN information cycle period.

Here, each resource location consists of consecutive M radio frames, M is preferably 2, 4 or 8; as shown in FIG. 10, X=2^{Y}=16, 16 resource locations for carrying SFN indication information are allocated at an equal interval in an SFN cycle period; the interval between resource locations has a length of preset fixed radio frames, i.e., P=2^{10-Y}=64 radio frames; when M=2, as shown in FIG. 10 (a), the base station repeatedly transmits the SFN indication information over radio frames with SFNs of 62, 63, 126, 127, 190, 191, . . . , 894, 895, 958, 959, 1022 and 1023; when M=4, as shown in FIG. 10(b), the base station repeatedly transmits the SFN indication information over radio frames with SFNs of 60, 61, 62, 63, 124, 125, 126, 127, 188, 189, 190, 191, . . . , 893, 894, 895, 956, 957, 958, 959, 1020, 1021, 1022 and 1023; and when M=8, as shown in FIG. 10(c), the base station repeatedly transmits the SFN indication information over radio frames with SFNs of 56, 57, 58, 59, 60, 61, 62, 63, 120, 121, 122, 123, 124, 125, 126, 127, 184, 185, 186, 187, 188, 189, 190, 191, . . . , 952, 953, 954, 955, 956, 957, 958, 959, 1016, 1017, 1018, 1019, 1020, 1021, 1022 and 1023.

Step 202: The base station transmits the SFN indication information at at least one resource location in each SFN information cycle period, and the SFN indication information includes the SFN corresponding to the resource location.

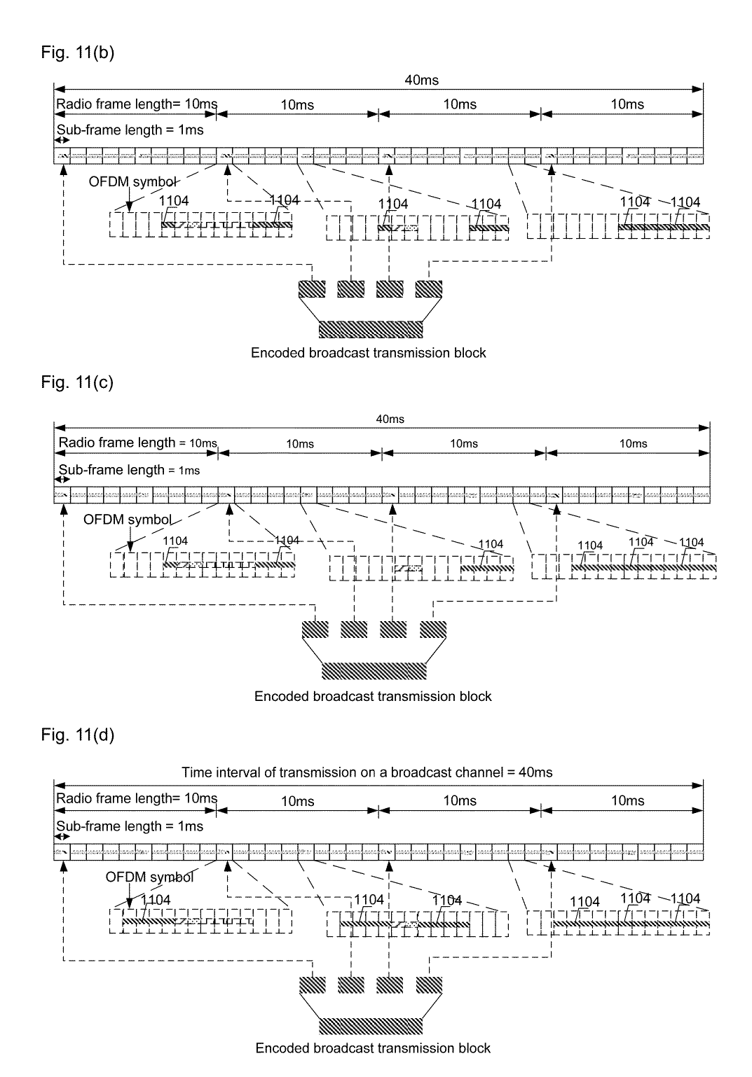

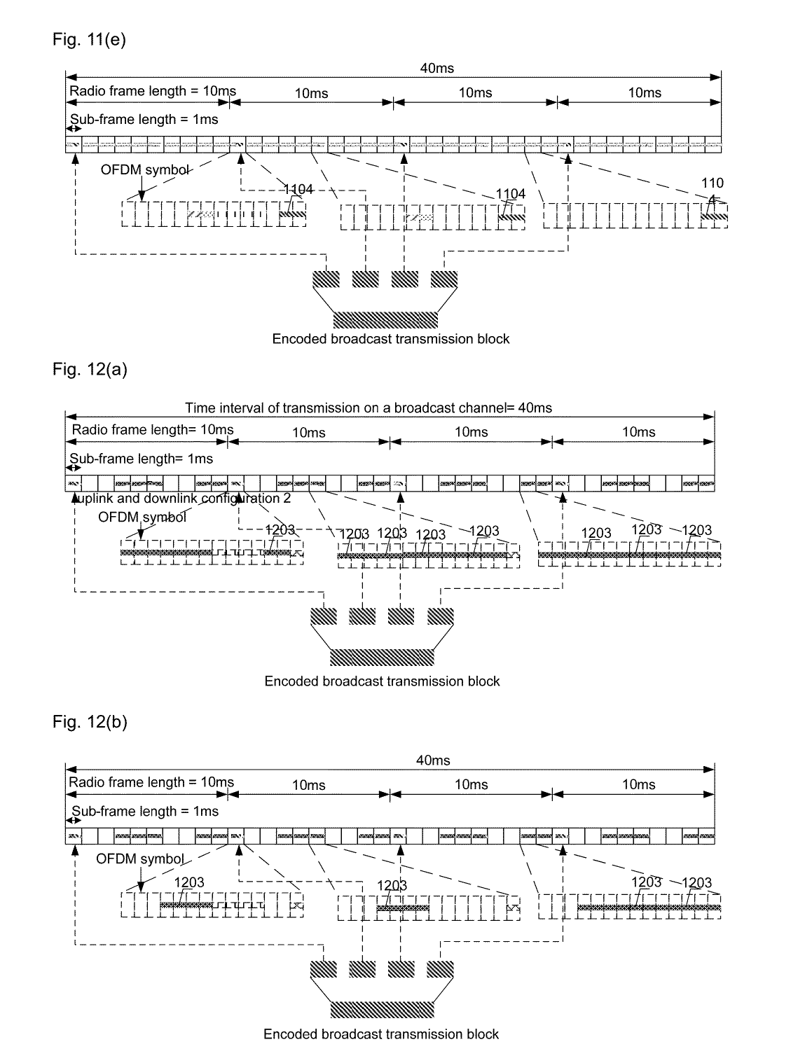

Specifically, each resource location consists of consecutive M radio frames, the base station transmits the SFN indication information over K sub-frames of each of the M radio frames, and for an FDD system, K is preferably 1, 2, 4, 5 or 10; preferably, an enhanced broadcast channel for bearing the SFN indication information is transmitted over the K sub-frames, and two or four OFDM symbols in one sub-frame, or all the available OFDM symbols in one time slot, or all the available symbols except the first three symbols in one sub-frame, or all the available OFDM symbols in one sub-frame are used for transmitting the enhanced broadcast channel; and in an FDD system, the example of OFDM symbol level resources occupied by a typical enhanced broadcast channel is as shown in FIG. 11, but is not limited to the example in FIG. 11, wherein

the OFDM symbol level-resources occupied by the enhanced broadcast channel are as shown in FIG. 11 (a); in the sub-frame #0, the enhanced broadcast channel 1104 occupies the central six Resource Blocks (RBs) of the last three OFDM symbols of a second time slot and the third OFDM symbol from the end of a first time slot; in the sub-frame #5, the enhanced broadcast channel occupies the central six RBs of the first four OFDMs of the second time slot, and in other sub-frames, the enhanced broadcast channel occupies the central six RBs of the last four OFDM symbols of the second time slot and the last four OFDM symbols of the first time slot; or,

the OFDM symbol resources occupied by the enhanced broadcast channel are as shown in FIG. 11 (b); in the sub-frames #0 and #5, the enhanced broadcast channel occupies the central six RBs of the last three OFDM symbols of the second time slot and the third OFDM symbol from the end of the first time slot, and in other sub-frames, the enhanced broadcast channel occupies the central six RBs of all the OFDM symbols of the second time slot; or,

the OFDM symbol resources occupied by the enhanced broadcast channel are as shown in FIG. 11 (c); in the sub-frames #0 and #5, the enhanced broadcast channel occupies the central six RBs of the last three OFDM symbols of the second time slot and the third OFDM symbol from the end of the first time slot, and in other sub-frames, the enhanced broadcast channel occupies the central six RBs of all the OFDM symbols except the first three symbols; or,

the OFDM symbol resources occupied by the enhanced broadcast channel are as shown in FIG. 11 (d); in the sub-frame #0, the enhanced broadcast channel occupies the central six RBs of the first to the fifth OFDM symbols of the first time slot; in the sub-frame #5, the enhanced broadcast channel occupies the central six RBs of the first four OFDM symbols of the second time slot; and in other sub-frames, the enhanced broadcast channel occupies the central six RBs of all the OFDM symbols except the first two symbols; or,

the OFDM symbol resources occupied by the enhanced broadcast channel are as shown in FIG. 11 (e); in all the sub-frames, the enhanced broadcast channel occupies the central six RBs of the last two OFDM symbols.

In a TDD system, the OFDM symbol level-resources occupied by different enhanced broadcast channels can be selected according to the different number of the consecutive M radio frames; for uplink and downlink configuration 2, the OFDM symbol resources occupied by the enhanced broadcast channel can be selected from the enhanced broadcast channel resources shown in FIG. 12(a); as shown in FIG. 12(b), the OFDM symbol resources occupied by the enhanced broadcast channel occupy the central six RBs of the last four OFDM symbols of the first time slot in the sub-frames #0 and #5 and occupy all the OFDM symbols except the first three symbols in other downlink sub-frames.

The M radio frames are divided into H (1<=H<=M) radio frame group(s), and different radio frames correspond to different scrambling codes; each radio frame group includes L radio frames, the SFN indication information is encoded and then divided into L parts, and each part is repeatedly transmitted in one radio frame; the SFN indication information repeatedly transmitted over the radio frame can be the MIB of a traditional LTE system or the combined information of an SFN and repetition times of a system message/a control message; as shown in FIG. 11, in an FDD system, the SFN indication information is repeatedly transmitted on an enhanced broadcast channel 1104 of the radio frame; and as shown in FIG. 12, in a TDD system, the SFN indication information is repeatedly transmitted on an enhanced broadcast channel 1203 of the radio frame.

If each resource location consists of two or four consecutive M radio frames, the SFN indication information transmitted repeatedly may be the MIB of the traditional LET system or other indication information containing an SFN; and the other indication information containing an SFN can be SFN information or the combined information of the SFN and repetition times of a system message/a control message; and if each resource location consists of eight consecutive M radio frames, the SFN indication information transmitted repeatedly contains an SFN of seven bits.

In addition, the SFN indication information may further contain information about repetition times of a system message or a control message, wherein seven bits can be encoded according to eight parts of resources; then, the encoded seven bits are divided into eight parts, each of which is transmitted repeatedly in one radio frame; or, the seven bits can be encoded according to four parts of resources, then, the encoded seven bits are divided into four parts, each of which is transmitted repeatedly in one radio frame; in addition, the scrambling codes corresponding to the first four radio frames in the eight radio frames are different from that corresponding to the last four radio frames.

As shown in FIG. 3, the processing step for a terminal side includes:

Step 301: A terminal detects SFN indication information which is repeatedly transmitted at each resource location in an SFN information cycle period to obtain an SFN of the current frame.

As shown in FIG. 10(a), the base station repeatedly transmits the SFN indication information over radio frames with SFNs of 62, 63, 126, 127, 190, 191, . . . , 894, 895, 958, 959, 1022 and 1023; or, as shown in FIG. 10(b), the base station repeatedly transmits the SFN indication information over radio frames with SFNs of 60, 61, 62, 63, 124, 125, 126, 127, 188, 189, 190, 191, . . . , 892, 893, 894, 895, 956, 957, 958, 959, 1020, 1021, 1022 and 1023; or, as shown in FIG. 10(c), the base station repeatedly transmits the SFN indication information over radio frames with SFNs of 56, 57, 58, 59, 60, 61, 62, 63, 120, 121, 122, 123, 124, 125, 126, 127, 184, 185, 186, 187, 188, 189, 190, 191, . . . , 952, 953, 954, 955, 956, 957, 958, 959, 1016, 1017, 1018, 1019, 1020, 1021, 1022 and 1023; and if the SFN indication information is the MIB of a traditional LTE system, the terminal combines the detected SFN indication information with the MIB received from a traditional broadcast message and decodes the combined information to obtain an SFN.

Step 302: Before acquiring a next SFN, the terminal computes the SFN of a subsequent radio frame according to own timing.

In the embodiment, by transmitting the SFN indication information repeatedly and densely over consecutive multiple radio frames at an interval of 2^{10-Y} (0<Y<10) radio frames, the synchronization of SFN information between an MTC terminal device and a base station side in a low-coverage environment can be ensured on the premise of reducing the system overhead without influencing the time delay of synchronizing the SFN of the terminal obviously, and the normal communication requirement of the MTC terminal device can be ensured.

As seen above, according to the method for transmitting the SFN information provided by the embodiment of the disclosure, by transmitting high-density SFN indication information discontinuously or transmitting low-density SFN indication information continuously, the coverage performance of a smart metering MTC terminal device deployed in a low-coverage environment is improved on the premise of ensuring the system overhead, and the normal communication requirement of the MTC terminal device is ensured on the premise of ensuring no additional addition of a site and a relay station.

The above are only the preferred embodiments of the disclosure, and are not intended to limit the scope of protection of the claims of the disclosure.

What is claimed is:

1. A method for transmitting System Frame Number (SFN) information, comprising:
setting, by a base station, X resource locations for carrying SFN indication information in one SFN information cycle period; and
transmitting, by the base station, the SFN indication information at at least one resource location in each SFN information cycle period.

2. The method according to claim 1, wherein each resource location consists of a single radio frame or consecutive M radio frames.

3. The method according to claim 2, wherein
X=2^{Y}, Y>=0 and Y<=10; and
the M is 2, 4, 8, 16, 32 or 64.

4. The method according to claim 1,
further comprising:
when X=1, in one SFN cycle period, setting, by the base station, one resource location for carrying the SFN indication information; and
in two adjacent SFN cycle periods, setting an interval between resource locations for transmitting the SFN indication information to be equal to the SFN cycle period, which has a length of 1024 radio frames;
or,
further comprising: when X=1024 and the cycle period is 1024, in the SFN cycle period, setting the resource location for carrying the SFN indication information to be all the radio frames in the SFN cycle period, and setting each resource location to correspond to one radio frame;
or,
further comprising: encoding the SFN indication information and transmitting the encoded SFN indication information at the resource location; or, mapping the SFN indication information into a predefined sequence, and transmitting the predefined sequence corresponding to the SFN indication information at the resource location;
or,
further comprising: dividing, by the base station, the SFN indication information into two parts, and transmitting the two parts of information over different channels respectively.

5. (canceled)

6. The method according to claim 3, wherein when 0<Y<10, initial radio frame numbers of the X resource locations are allocated at an equal interval in the SFN cycle period.

7. The method according to claim 6, further comprising:
when 0<Y<10 and each resource location consists of a single radio frame, repeatedly transmitting, by the base station, the SFN indication information over single radio frames at an interval of P=2^{10-Y} radio frames.

8. (canceled)

9. The method according to claim 1, wherein the SFN indication information is a Master Information Block (MIB) of a Long Term Evolution (LTE) system, or indication information containing an SFN.

10. The method according to claim 9, wherein the indication information containing an SFN comprises:
indication information only comprising an SFN, or
indication information comprising an SFN and repetition times of a system message, or
indication information comprising an SFN and repetition times of a control channel, or
indication information comprising an SFN, repetition times of a system message and repetition times of a control channel.

11. The method according to claim 3, further comprising:
transmitting the SFN indication information over K sub-frames of each of the consecutive M radio frames, where K is 1, 2, 4, 5 or 10.

12. The method according to claim 11, further comprising:
transmitting an enhanced broadcast channel bearing the SFN indication information in the K sub-frames, wherein two or four Orthogonal Frequency Division Multiplexing (OFDM) symbols in one sub-frame, or all available OFDM symbols in one time slot, or all available symbols except the first three symbols in one sub-frame, or all available OFDM symbols in one sub-frame are used for transmitting the enhanced broadcast channel.

13. The method according to claim 3, further comprising:
dividing the consecutive M radio frames into H radio frame groups,
wherein different radio frame groups correspond to different scrambling codes, and H is an integer more than or equal to 1 and less than or equal to M; and each of the H radio frame groups comprises L radio frames, the SFN indication information is encoded and then divided into L parts, and each part is repeatedly transmitted within one radio frame.

14. (canceled)

15. A method for transmitting System Frame Number (SFN) information, comprising:
detecting, by a terminal, SFN indication information which is transmitted at each resource location in an SFN information cycle period to obtain an SFN of a current frame, wherein X resource locations for carrying the SFN indication information are set in one SFN information cycle period.

16. The method according to claim 15,
further comprising: when X=1, acquiring, by the terminal, the SFN indication information at an interval of 1024 radio frames by blind detection in each SFN cycle period;
or,
further comprising: when X=1024 and the cycle period is 1024, detecting, by the terminal, the SFN indication information transmitted over each radio frame to acquire the SFN indication information;
or,
further comprising:
when the SFN indication information is encoded and then transmitted at the resource location, carrying out decoding, by the terminal, according to a corresponding encoding method; or,
when the SFN indication information is mapped into a predefined sequence and the sequence corresponding to the SFN indication information is transmitted at the resource location, carrying out detection, by the terminal, according to a corresponding sequence;
or,
further comprising: when the SFN indication information is divided into two parts, carrying out decoding, by the terminal, according to a channel corresponding to each part to acquire the SFN indication information.

17-18. (canceled)

19. The method according to claim 15, further comprising:
when each resource location consists of consecutive M radio frames, carrying out detection, by the terminal, with the consecutive M radio frames as a unit.

20. The method according to claim 19, further comprising:
when the consecutive M radio frames are divided into H radio frame groups, carrying out decoding, by the terminal, according to a scrambling code sequence corresponding to each radio frame group.

21. The method according to claim 20, further comprising:
when the SFN indication information is encoded and then divided into L parts, carrying out decoding, by the terminal, according to a dividing way of the SFN indication information.

22. (canceled)

23. A base station, comprising a setting module and a transmitting module, wherein
the setting module is configured to set X resource locations for carrying System Frame Number (SFN) indication information in an SFN information cycle period; and
the transmitting module is configured to transmit the SFN indication information at at least one resource location in each SFN information cycle period.

24. The base station according to claim 23, wherein each resource location consists of a single radio frame or consecutive M radio frames, X=2^{Y}, Y>=0 and Y<=10, and the M is 2, 4, 8, 16, 32 or 64, wherein
when 0<Y<10, initial radio frame numbers of the X resource locations are allocated at an equal interval in the SFN cycle period, and the transmitting module is further configured to: when 0<Y<10 and each resource location consists of a single radio frame, repeatedly transmit the SFN indication information over single radio frames at an interval of P=2^{10-Y} radio frames;
or,
the transmitting module is further configured to transmit the SFN indication information over K sub-frames of each of the consecutive M radio frames, where K is 1, 2, 4, 5 or 10, and the transmitting module is further configured to transmit an enhanced broadcast channel bearing the SFN indication information in the K sub-frames, wherein two or four OFDM symbols in one sub-frame, or all available OFDM symbols in one time slot, or all available symbols except the first three symbols in one sub-frame, or all available OFDM symbols in one sub-frame are used for transmitting the enhanced broadcast channel;
or,
the transmitting module is further configured to divide the consecutive M radio frames into H radio frame groups, wherein different radio frame groups correspond to different scrambling codes, and H is an integer more than or equal to 1 and less than or equal to M; and each of the H radio frame groups comprises L radio frames, the SFN indication information is encoded and then divided into L parts, and each part is repeatedly transmitted within one radio frame.

25. (canceled)

26. The base station according to claim 23, wherein
the setting module is configured to:
when X=1, in one SFN cycle period, set one resource location for carrying the SFN indication information; and
in two adjacent SFN cycle periods, set an interval between resource locations for transmitting the SFN indication information to be equal to the SFN cycle period, which has a length of 1024 radio frames;
or,
the setting module is further configured to: when X=1024 and the cycle period is 1024, set the resource location for carrying the SFN indication information to be all the radio frames in the SFN cycle period and set each resource location to correspond to one radio frame in the SFN cycle period;
or,
the transmitting module is further configured to:
encode the SFN indication information and transmit the encoded SFN indication information at the resource location; or,
map the SFN indication information into a predefined sequence and transmit the sequence corresponding to the SFN indication information at the resource location;
or,
the transmitting module is further configured to divide the SFN indication information into two parts, and transmit the two parts of information over different channels respectively.

27-30. (canceled)

31. The base station according to claim 23, wherein the SFN indication information is a Master Information Block (MIB) of a Long Term Evolution (LTE) system, or indication information containing an SFN.

32. The base station according to claim 31, wherein the indication information containing an SFN comprises:
indication information only comprising an SFN, or
indication information comprising an SFN and repetition times of a system message, or
indication information comprising an SFN and repetition times of a control channel, or
indication information comprising an SFN, repetition times of a system message and repetition times of a control channel.

33-36. (canceled)

37. A terminal, comprising:
a detecting module, which is configured to detect System Frame Number (SFN) indication information which is transmitted at each resource location in an SFN information cycle period to obtain an SFN of a current frame, wherein
X resource locations for carrying SFN indication information are set in one SFN information cycle period.

38. The terminal according to claim 37, further comprising a computing module, which is configured to compute an SFN of a subsequent radio frame.

39. The terminal according to claim 37, wherein
the detecting module is configured to, when X=1, acquire the SFN indication information at an interval of 1024 radio frames by blind detection in each SFN cycle period;
or,
the detecting module is configured to: when X=1024 and the cycle period is 1024, detect the SFN indication information transmitted over each radio frame to acquire the SFN indication information;
or,
the detecting module is configured to:
when the SFN indication information is encoded and then transmitted at the resource location, carry out decoding according to a corresponding encoding method; or,
when the SFN indication information is mapped into a predefined sequence and the sequence corresponding to the SFN indication information is transmitted at the resource location, carry out detection according to a corresponding sequence;
or,
the detecting module is configured to, when each resource location consists of consecutive M radio frames, carry out detection with the consecutive M radio frames as a unit; and further configured to, when the consecutive M radio frames are divided into H radio frame groups, carry out decoding according to a scrambling code sequence corresponding to each radio frame group; and then further configured to, when the SFN indication information is encoded and then divided into L parts, carry out decoding according to a dividing way of the SFN indication information;
or,
the detecting module is further configured to: when the SFN indication information is divided into two parts, carry out decoding according to a channel corresponding to each part to acquire the SFN indication information.

40-46. (canceled)
